(19) United States
(12) Patent Application Publication
(10) Pub. No.: US 2012/0291450 A1
(43) Pub. Date: Nov. 22, 2012

(54) AUXILIARY POWER UNIT MOUNTING FEATURE

(75) Inventors: Brian C. DeDe, San Diego, CA (US); Jack V. Vitale, San Diego, CA (US); Markissa Catherine Hiekel, San Diego, CA (US)

(73) Assignee: HAMILTON SUNDSTRAND CORPORATION, Windsor Locks, CT (US)

(21) Appl. No.: 13/196,040

(22) Filed: Aug. 2, 2011

Related U.S. Application Data
(60) Provisional application No. 61/486,544, filed on May 16, 2011.

(51) Int. Cl. F02C 7/20

(52) U.S. Cl. 60/796

(57) ABSTRACT

An auxiliary power unit assembly includes an auxiliary power unit with an auxiliary power unit exhaust duct, a bell mouth, and one or more bell mouth struts. The auxiliary power unit exhaust duct extends from the auxiliary power unit and has an aft end portion that is received within the bell mouth. The bell mouth struts extend from an inner surface of the bell mouth and extend generally radially toward the auxiliary power unit exhaust duct.

### CROSS-REFERENCE TO RELATED APPLICATION

This Application claims the benefit of Provisional Application No. 61/486,544 filed on May 16, 2011, and entitled “AUXILIARY POWER UNIT MOUNTING FEATURE”, the entire content of which is expressly incorporated by reference.

### BACKGROUND

The present invention relates to auxiliary power units (APUs). In particular, the present invention relates to a mounting system for restraining the APU should one or more struts retaining the APU in position fail.

Many aircraft typically include on-board APUs, located in the tail sections of the aircraft, to provide electrical power and compressed air for systems throughout the aircraft. When an aircraft is on the ground, the primary propulsion engines of the aircraft are shut down, and the APU provides the main power source for a variety of systems and serves as a main engine starter. The APU may also provide power during in-flight operations for various systems.

The APU is supported within a compartment in the tail section of the aircraft by a plurality of mount struts (typically six or more). These mount struts operate to constrain the APU from movement relative to other components within the tail section (e.g., a bell mouth, tailcone structure, an exhaust silencer, and an exhaust pipe). APUs must be certified as failsafe. This certification requires that the APU cannot become disattached from the tail section under any operating condition. In the past, to meet this requirement redundant mount struts were added to the tail section to further restrain the APU. Unfortunately, redundant mount struts add to the overall weight of the aircraft, add preload into the system that must be accounted for, and make installation of the APU more complicated.

### SUMMARY

An auxiliary power unit assembly includes an auxiliary power unit with an auxiliary power unit exhaust duct, a bell mouth, and one or more bell mouth struts. The auxiliary power unit exhaust duct extends from the auxiliary power unit and has an aft end portion that is received within the bell mouth. The bell mouth struts extend from an inner surface of the bell mouth and extend generally radially toward the auxiliary power unit exhaust duct.

### BRIEF DESCRIPTION OF THE DRAWINGS

FIG. 1 is a schematic view of an aircraft tail section, which includes an on-board APU extending to a bell mouth.

FIG. 1A is a cross-sectional view taken along line A-A of FIG. 1 showing the bell mouth, APU exhaust duct, and bell mouth struts.

### DETAILED DESCRIPTION

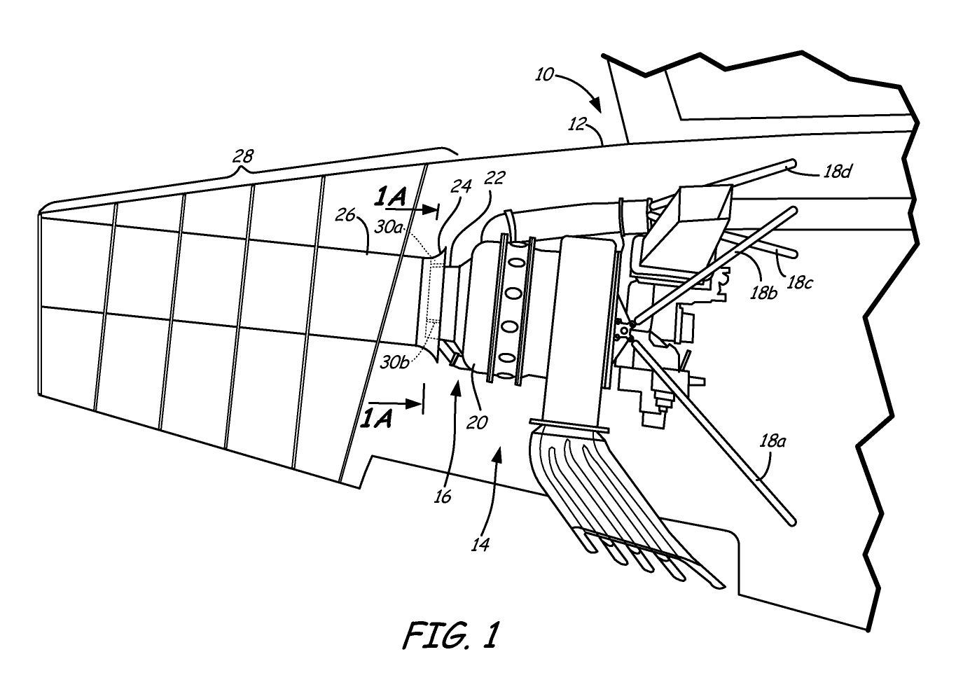

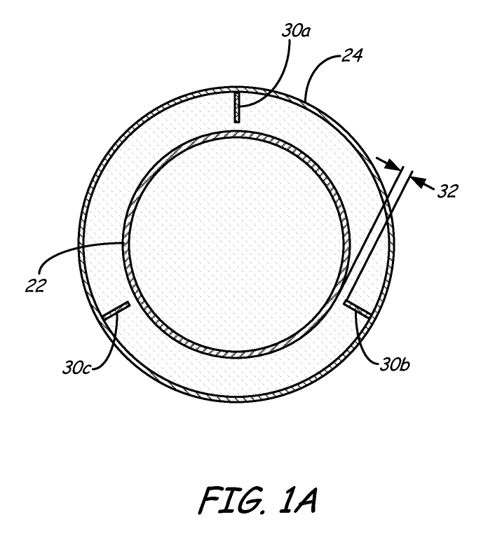

FIG. 1 is a schematic view of aircraft tail section 10, which includes an exterior structure 12 and an APU nacelle 14. APU nacelle 14 is a compartment within exterior structure 12. APU nacelle 14 contains an APU 16 and mount struts 18a, 18b, 18c, and 18d. APU 16 includes a turbine section 20 and an APU exhaust duct 22. Additionally, exterior structure 12 houses a bell mouth 24, an exhaust pipe 26, an exhaust silencer 28, and bell mouth struts 30a and 30b.

APU nacelle 14 houses APU 16 and mount struts 18a, 18b, 18c, and 18d therein. Mount struts 18a, 18b, 18c, and 18d extend in various directions from APU 16 to contact structure 12. In FIG. 1, four mount struts 18a, 18b, 18c, and 18d are shown, however in most embodiments additional mount struts (not shown) would also be utilized. APU 16 is an on-board APU engine that includes turbine section 20 with APU exhaust duct 22 arranged aft thereof. APU 16 provides electrical power to the aircraft. APU 16 also includes additional components (not shown) that facilitate the operation of APU 16 and the transfer of electrical power (e.g., inlet air ducts, gearboxes, and generators). Although commonly located in aircraft tail section 10, any suitable location on the aircraft could be utilized.

Bell mouth 24 is arranged downstream of and is in fluid communication with APU 16. Bell mouth 24 has an axial length with an upstream end that is flared and a downstream end that has a smaller diameter than the upstream end. Bell mouth 24 is an airflow system that extends annularly around aft end portions of APU exhaust duct 22. Bell mouth 24 extends axially aft to connect to and communicate with exhaust pipe 26. Exhaust silencer 28 is disposed annularly around exhaust pipe 26 and is configured to attenuate the noise of APU 16. More particularly, exhaust silencer 28 has an array of baffles spaced apart axially from one another and extending annularly around exhaust pipe 26 to form tuned chambers to attenuate noise that results from the combustion gases of APU 16. Bell mouth struts 30a, 30b, and 30c (FIG. 1A) are circumferentially spaced from one another along an inner surface of bell mouth 24 and extend radially inward toward APU exhaust duct 22. Bell mouth struts 30a, 30b, and 30c (FIG. 1A) extend part of the axial length of bell mouth 24 and define an inner diameter that is larger than that of an outer diameter of APU exhaust duct 22. The structure and function of bell mouth struts 30a, 30b, and 30c (FIG. 1A) will be discussed in further detail subsequently.

APU 16 compresses combustion air, adds fuel, and combusts the resulting fuel/air mixture. The resulting hot, high-pressure combustion gas then expands through a turbine stage (not shown) within turbine section 20. The resulting rotation of the turbines is used to generate electrical power for associated devices of the aircraft (not shown). The spent combustion gases exit through APU exhaust duct 22, and flow into bell mouth 24.

Bell mouth 24 acts to draw cooling air from APU compartment 14 and mix the cooling air with the spent combustion gases from APU 16 passing through APU exhaust duct 22. Exhaust pipe 26 communicates with bell mouth 24 and provides a channel for expelling the combustion and cooling gases from aircraft tail section 10. Bell mouth 24 and exhaust pipe 26 generally comprise an annular duct constructed of a sheet metal. Bell mouth struts 30a and 30b do not inhibit the compartment cooling air drawn out exhaust pipe 26.

In the embodiment shown in FIG. 1, mount struts 18a, 18b, 18c, and 18d support APU 16 relative to fixed structures such as exterior structure 12, bell mouth 24, exhaust pipe 26, and exhaust silencer 28. Mount struts 18a, 18b, 18c, and 18d and additional mount struts (not shown) adequately restrain all degrees of freedom of APU 16 during typical operation. However, should one or more mount struts 18a, 18b, 18c, and 18d or additional mount struts (not shown) fail, APU 16 will no longer be adequately restrained and will begin to move relative to fixed structures such as exterior structure 12, bell mouth 24, exhaust pipe 26, and exhaust silencer 28. Such movement would typically lead to rapid failure of additional components including additional mount struts 18a, 18b, 18c, and 18d and possibly lead to APU 16 deflecting out of communication with bell mouth 24. As will be discussed in more detail subsequently, radially extending bell mouth struts 30a-30c (FIG. 1A) can be disposed in the interior of bell mouth 24 between generally annular bell mouth 24 and APU exhaust duct 22. Fail safe struts 30a-30c are configured to support APU 16 via APU exhaust duct 22 should a failure of one of mount struts 18a, 18b, 18c, and 18d or additional mount struts (not shown) occur. Such a failure would cause APU 16 to deflect slightly, which would bring APU exhaust duct 22 into contact with one or more of bell mouth struts 30a-30c. Bell mouth struts 30a-30c are constructed and sized to prevent deflection of APU 16 out of communication with bell mouth 24 and will prevent movement (deflection) of APU 16 that would cause failure of additional components (e.g., additional mount struts 18a, 18b, 18c, and 18d, exterior structure 12, bell mouth 24, exhaust pipe 26, and exhaust silencer 28).

FIG. 1A is a cross-sectional view taken along line 1A-1A of FIG. 1 showing the bell mouth 24, APU exhaust duct 22, and bell mouth struts 30a-30c. Although three bell mouth struts 30a-30c are illustrated in FIG. 1A at 120° intervals, in other embodiments a different number of bell mouth struts can be utilized. Bell mouth struts 30a-30c extend generally radially from the inner annular surface of bell mouth 24 inward toward the outer surface of APU exhaust duct 22. Bell mouth struts 30a-30c can extend axially along bell mouth 24 from the forward-most edge of bell mouth 24 adjacent APU 16, aft to the end of APU exhaust duct 22. The thickness and number of bell mouth struts 30a-30c would vary depending on design criteria, which include: the weight of APU 16, the size and thickness of bell mouth 24, and the materials used for bell mouth struts 30a-30c and bell mouth 24. An analysis of the stresses on bell mouth struts 30a-30c in view of all applicable design criteria would determine the thickness, length, number, and required rigidity of bell mouth struts 30a-30c.

Bell mouth struts 30a-30c connect to and extend generally radially from the inner annular surface of bell mouth 24 inward toward the outer surface of APU exhaust duct 22 but terminate adjacent APU exhaust duct 22 without making contact. This leaves a gap 32 between bell mouth struts 30a-30c and APU exhaust duct 22. The size of gap 32 will be application specific but should account for expected movement of APU exhaust duct 22 and bell mouth 24 relative one another due to aircraft maneuvers (e.g., hard landings), thermal growth, and spatial tolerances.

As discussed previously, fail safe struts 30a-30c are configured to support APU 16 via APU exhaust duct 22 should a failure of one of mount struts 18a, 18b, 18c, and 18d or additional mount struts (not shown) occur. Such a failure would cause APU 16 to become unconstrained and deflect slightly, which would bring APU exhaust duct 22 into contact with one or more of bell mouth struts 30a-30c. Bell mouth struts 30a-30c are constructed and sized to prevent deflection of APU 16 out of communication with bell mouth 24 and will prevent unconstrained movement (deflection) of APU 16 that would cause failure of additional components (e.g., additional mount struts 18a, 18b, 18c, and 18d, exterior structure 12, bell mouth 24, exhaust pipe 26, and exhaust silencer 28).

By using bell mouth struts 30a-30c, the use of redundant mount struts (in addition to mount struts 18a, 18b, 18c, and 18d) can be avoided. By avoiding the use of redundant mount struts, the overall weight of the aircraft can be maintained rather than increased, additional preload in the system can be avoided, and installation of APU 16 can be simplified.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An auxiliary power unit assembly, comprising:
an auxiliary power unit with an auxiliary power unit exhaust duct extending therefrom;
a bell mouth disposed annularly about an end portion of the exhaust duct; and
one or more bell mouth struts extending from an inner surface of the bell mouth and extending generally radially toward the auxiliary power unit exhaust duct.

2. The assembly of claim 1, wherein the bell mouth struts comprise three struts disposed at a 120° interval from one another.

3. The assembly of claim 1, wherein the one or more bell mouth struts extend radially to adjacent the auxiliary power unit exhaust duct leaving a gap therebetween to allow for constrained movement of the auxiliary power unit exhaust duct relative to the bell mouth.

4. The assembly of claim 1, wherein the one or more bell mouth struts are positioned to engage and support the auxiliary power unit via the auxiliary power unit duct in the event of an unconstrained movement of the auxiliary power unit exhaust duct relative to the bell mouth.

5. The assembly of claim 1, wherein the one or more bell mouth struts extend axially along the inner surface of the bell mouth and terminate at an aft end of the auxiliary power unit exhaust duct.

6. The assembly of claim 1, wherein the one or more bell mouth struts extend axially along the inner surface of the bell mouth and terminate at a forward end of the bell mouth.

7. The assembly of claim 1, wherein the one or more bell mouth struts define an inner diameter that is larger than that of an outer diameter of the auxiliary power unit exhaust duct.

8. An aircraft tail section comprising:
an auxiliary power unit with an auxiliary power unit exhaust duct extending therefrom, the auxiliary power unit supported within the aircraft tail section by one or more mount struts;
a bell mouth disposed downstream from the auxiliary power unit and extending generally annularly around an end portion of the auxiliary power unit exhaust duct; and
one or more bell mouth struts extending from an inner surface of the bell mouth and extending generally radially toward the auxiliary power unit exhaust duct.

9. The aircraft tail section of claim 8, wherein the one or more bell mouth struts extend radially to adjacent the auxiliary power unit exhaust duct leaving a gap therebetween to allow for constrained movement of the auxiliary power unit exhaust duct relative to the bell mouth.

10. The aircraft tail section of claim 8, wherein the one or more bell mouth struts are positioned to engage and support the auxiliary power unit via the auxiliary power unit duct in the event of an unconstrained movement of the auxiliary power unit exhaust duct relative to the bell mouth.

11. The aircraft tail section of claim 8, wherein the one or more bell mouth struts extend axially along the inner surface of the bell mouth and terminate at an aft end of the auxiliary power unit exhaust duct.

12. The aircraft tail section of claim 8, wherein the wherein the one or more bell mouth struts extend axially along the inner surface of the bell mouth and terminate at a forward end of the bell mouth.

13. An assembly comprising:
an annular bell mouth having an axial length with a flared upstream end and a downstream end that is of a smaller diameter than the upstream end; and
one or more bell mouth struts circumferentially spaced along an inner surface of the bell mouth and extending radially inward, the one or more bell mouth struts extend part of the axial length of the bell mouth.

14. The assembly of claim 13, wherein the bell mouth struts extend generally radially inward from the annular inner surface.

15. The assembly of claim 13, wherein the bell mouth struts comprise three struts disposed at a 120° interval from one another.

16. The assembly of claim 13, further comprising an auxiliary power unit exhaust duct disposed radially inward of the bell mouth, and wherein the one or more bell mouth struts extend radially to adjacent the auxiliary power unit exhaust duct leaving a gap therebetween to allow for constrained movement of the auxiliary power unit exhaust duct relative to the bell mouth.

17. The assembly of claim 16, wherein the one or more bell mouth struts are positioned to engage and support the auxiliary power unit via the auxiliary power unit duct in the event of an unconstrained movement of the auxiliary power unit exhaust duct relative to the bell mouth.

18. The assembly of claim 16, wherein the one or more bell mouth struts define an inner diameter that is larger than that of an outer diameter of the auxiliary power unit exhaust duct.

19. The assembly of claim 16, wherein the one or more bell mouth struts extend axially along the inner surface of the bell mouth and terminate at an aft end of the auxiliary power unit exhaust duct.

20. The assembly of claim 13, wherein the one or more bell mouth struts extend axially along the inner surface of the bell mouth and terminate at a forward end of the bell mouth.
